(19) United States
(12) Patent Application Publication
(10) Pub. No.: US 2006/0002260 A1
(43) Pub. Date: Jan. 5, 2006

(54) Information recording device

(76) Inventors: Yoshiteru Mino, Osaka (JP); Atsushi Yamada, Osaka (JP)

Correspondence Address: MCDERMOTT WILL & EMERY LLP, 600 13TH STREET, N.W., WASHINGTON, DC, 20005-3096, US

(21) Appl. No.: 11/170,059

(22) Filed: Jun. 30, 2005

(30) Foreign Application Priority Data
Jun. 30, 2004 (JP) JP2004-193673
Feb. 1, 2005 (JP) JP2005-025560

(51) Int. Cl. G11B 5/09

(52) U.S. Cl. 369/47.1; 369/59.1

(57) ABSTRACT

An information recording device 20 includes an encoding unit 22 for encoding program data digitally converted by an ADC 21 from the signal of a user-selected broadcast received via a tuner 10, a split recording unit 23 for recording encoded program data split into fixed units to a fixed disk 24, a playback unit 25 for outputting decoded split data to a monitor 30 via a DAC 28, a compression unit 26 for recording compressed split data decoded by playback unit 25 to fixed disk 24, and an erase unit 27 for updating reference information stored on fixed disk 24 to show a storage location of the compressed split data rather than the split data.

### BACKGROUND OF INVENTION

1. Field of the Invention

The present invention relates to an information recording device, and in particular to a device that compresses and records video data.

2. Related Art

Conventional recording devices are able to receive the signal of an analog broadcast selected by a user and record program data that has been digitally converted and encoded to recording media such as hard disk.

In view of restrictions on the storage area in recording media, Japanese Patent Application Publication No. 2003-339016, for example, discloses a record/playback method that, during playback, compresses recorded data that has been played back at a lower bit rate than the recording bit rate, and records the compressed data to the recording medium.

According to this record/playback method, once all the played data of a given program has been compressed, the compressed data is available for playback and the storage area of the pre-compression recorded data is released, enabling the storage area on disk to be used effectively.

However, with this record/playback method, the pre-compression recorded data cannot be erased until the compression is completely finished, meaning that the storage area cannot be released for further recording. Thus in the case of time-shift playback, for example, in which recorded sections of a program are played back while the program is being recorded, the storage area of recorded data cannot be released part way through the compression.

### SUMMARY OF INVENTION

The present invention, which was arrived at in view of the above problem, aims to provide an information recording device that allows the storage area of pre-compression program data to be released without waiting for compression to be completed.

To resolve the above problem, the present invention is an information recording device for compressing video data constituting a video stream read from a recording medium storing reference information that shows a storage location of the video data and is referred to in order to read the video data as the video stream. The information recording device includes: a reading unit operable to read part of the video data; a compressing unit operable to compress the read data and record the compressed data to the recording medium; and an updating unit operable, when the compressed data is recorded, to update the reference information to show the storage location of the compressed data rather than the read data.

According to this structure, the reference information is updated every time program data that has been played back is compressed and recorded, so that the compressed program data is read instead of the pre-compression program data. As a result, the pre-compression program data is no longer referred to during playback. Since the storage area of the pre-compression program data may then be freely overwritten with other program data, the above structure enables this storage area to be applied as free area when compressing and recording subsequent program data.

Here, the video data may consist of plural pieces of split video data, the reference information may show a storage location of each piece of split video data and a reference order of the storage locations, the read video data may be a piece of the split video data, and the updating unit may update the reference information when the compressed split data is recorded to show the storage location of the compressed split data rather than the read split data.

According to this structure, the program data has been split before being recorded, making it possible to perform the compressing/recording in units of split data, to update the reference information to refer to the compressed split data instead of the pre-compression split data whenever split data is compressed and recorded, and to release the storage area as free area per piece of split data.

Here, at least one piece of the split video data may include duplication information that indicates a certifier relating to duplication of the piece of split video data, and the information recording device may further include: a certification requesting unit operable, if the read split data includes the duplication information, to send a certification request to and receive a response from the certifier; and a control unit operable to control the compressing and recording by the compressing unit according to the received response.

According to this structure, if information relating to a certifier (i.e. copyright holder etc.) is included in the received program data, a certification request can be sent to the certifier in regard to duplicating program data that has been played back, and a response received from the certifier. If the response indicates COPY FREE, for example, the program data can be compressed and recorded at a compression rate selected by the user, whereas if the response indicates COPY ONCE, the program data can be erased after being compressed at a low bit rate.

The information recording device may further include: a capacity judging unit operable to judge whether a free capacity of the recording medium is at or below a prescribed threshold; and a recording unit operable to record video data constituting an externally acquired video stream to the recording medium together with the reference information, and if judged in the affirmative during recording of the video stream, the reading unit, the compressing unit and the updating unit may perform the reading, compressing/recording and updating on video data of the video stream being recorded.

According to this structure, if the free area on the recording medium falls below a prescribed capacity during the recording of a program, for example, data designated from the video data of the program being recorded can be compressed so as to release the storage area for further recording.

Here, each piece of split video data may include all or part of one of plural types of programs and classification information indicating the type of the program, and the compressing unit may change the compression rate at which the read split data is compressed depending on the classification information included therein.

According to this structure, content information indicating either “program content” or “CM” can be recorded per piece of split data, in the case of program data that includes program content data and CM data, for example, having been split before being recorded, thus enabling split data that has been played back to be compressed at a high compression rate if relating to a CM, and thereby increasing the free area by minimizing the storage area taken up by CM data.

Here, at least one piece of the split video data may include data that requires updating, the reading unit may include an acquiring subunit operable to judge whether the read split data include data that requires updating, and to externally acquire update data if judged in the affirmative, and the compressing unit may compress and record the read split data after replacing the data that requires updating with the acquired update data.

According to this structure, if recorded program data that includes CM data also includes information indicating the CM provider, for example, the latest CM data can be acquired from the provider and played back in place of the original CM data, and this replacement CM data can then be compressed and recorded after playback. Thus whenever the program is played back, the user is able to view the latest information, and the CM provider is able to provide the user with the latest information.

### BRIEF DESCRIPTION OF DRAWINGS

These and other objects, advantages, and features of the invention will become apparent from the following description thereof taken in conjunction with the accompanying drawings, which illustrate specific embodiments of the present invention.

In the drawings:

FIG. 1 is a structural view showing an embodiment 1 of an information recording device 20 pertaining to the present invention;

FIG. 2A shows a structure and an exemplary content of encoding information;

FIG. 2B shows a structure and an exemplary content of header information;

FIG. 2C shows a structure and an exemplary content of link information 200 for individual programs;

FIG. 3 is a flowchart of processing by a split recording unit 23;

FIG. 4 shows an overview of the processing performed by information recording device 20 on split data recorded on a fixed disk 24;

FIG. 5 is a flowchart of processing by a playback unit 25;

FIG. 6 is a flowchart of processing by a compression unit 26;

FIG. 7 is a flowchart of processing by an erase unit 27;

FIGS. 8A-8C demonstrate the change in the storage area of fixed disk 24 when split data is played back and compressed and link information is updated by information recording device 20;

FIG. 9 is a structural view showing an embodiment 2 of information recording device 20 pertaining to the present invention;

FIG. 10 is a flowchart of processing by a certification request unit 29; and

FIG. 11 is a flowchart of processing by compression unit 26 when split data includes content information.

### DETAILED DESCRIPTION OF PREFERRED EMBODIMENTS

### Embodiment 1

The following description relates to an embodiment 1 of an information recording device pertaining to the present invention.

Synopsis

The information recording device receives the data of broadcast programs (hereinafter “program data”) from an external source, and records split data derived by splitting encoded program data into units of fixed length to a fixed disk. The information recording device also records link information showing both the storage location of each piece of split data and the playback order of the split data in a specific area of the fixed disk.

The link information for managing the storage area of the fixed disk is referred to when recording data to and reading data from disk. Storage area not shown in the link information is treated as area freely available for further recording of program data (hereinafter “free area”).

When the user instructs the playback of a program recorded on the fixed disk, the information recording device sequentially reads and decodes split data constituting the program with reference to the link information, and outputs the decoded data to a monitor. The information recording device also compresses the decoded data to reduced the data size, records the compressed data to free area on the fixed disk, and updates the link information when the recording is performed to show the storage location of the compressed split data instead of the storage location of the pre-compression split data.

Structure

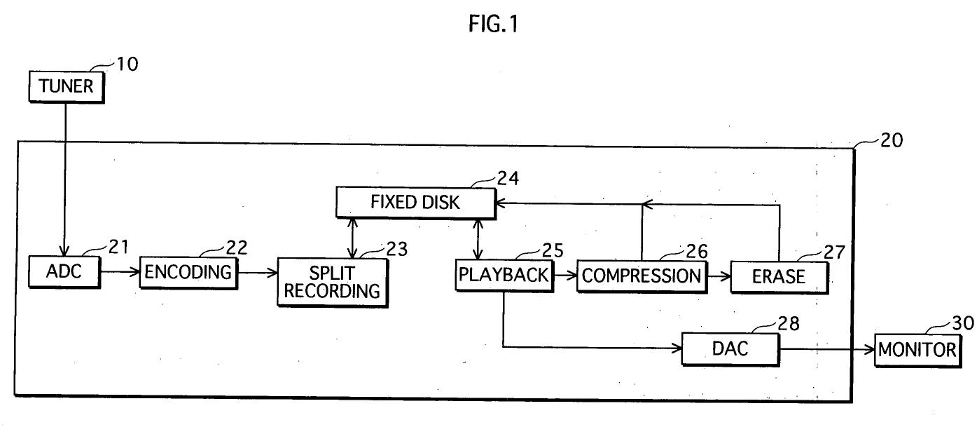

FIG. 1 is a structural view showing an embodiment 1 of an information recording device 20 pertaining to the present invention. The device structure is described in detail below with reference to FIG. 1.

Information recording device 20 is constituted from an analog-to-digital converter (ADC) 21, an encoding unit 22, a split recording unit 23, a fixed disk 24, a playback unit 25, a compression unit 26, an erase unit 27, and a digital-to-analog converter (DAC) 28.

ADC 21 functions to convert broadcast signals received via a tuner 10 to digital signals. The received signals are here assumed to include signals showing broadcast programs selected by the user as well as an electronic program guide (EPG).

Encoding unit 22 functions to encode program data digitally converted by ADC 21, and send the encoded data to split recording unit 23. MPEG is used here as the encoding scheme, and the encoding is performed at a bit rate shown in preset encoding information (described later).

Split recording unit 23 functions to receive encoded program data in a write buffer (not depicted), and record program data equal to the buffer capacity as a single piece of split data to free area on fixed disk 24 with reference to link information 200 (described later). Split recording unit 23 also functions to enter the storage locations of split data in link information 200 per program in the playback order.

Fixed disk 24 is a hard disk, a digital versatile disc (DVD) or similar recording medium.

Playback unit 25 functions to receive a user instruction to playback a program recorded on fixed disk 24, read split data constituting the program to a read buffer (not depicted) in accordance with link information 200, and decode the program data in the read buffer in units of split data. Playback unit 25 also functions to output the decoded split data to DAC 28, as well as to send the decoded split data to compression unit 26 together with the storage location.

Compression unit 26 functions to receive decoded split data from playback unit 25, compress the decoded data at a lower bit rate than the decoded data, and record the compressed split data to fixed disk 24.

Here, compression involves initially decoding and then re-encoding the split data at a bit rate shown in preset encoding information (described later) to reduce the data size, the re-encoding being performed at a lower bit rate than the pre-decoding data. MPEG is used here, although other encoding schemes may be applied provided the data size is reduced. Compression unit 26 sends information showing the storage location of the compressed split data (hereinafter “post-compression storage location”) and the storage location of the pre-compression split data (hereinafter “pre-compression storage location”) to erase unit 27.

Erase unit 27 functions to replace the pre-compression storage location with the post-compression storage location in link information 200 of the program relating to the pre-compression split data.

DAC 28 functions to convert decoded split data output from playback unit 25 to analog signals, and output the analog signals to monitor 30.

Monitor 30 is a liquid crystal display (LCD) etc. that functions to display analog signals sent from DAC 28.

Data

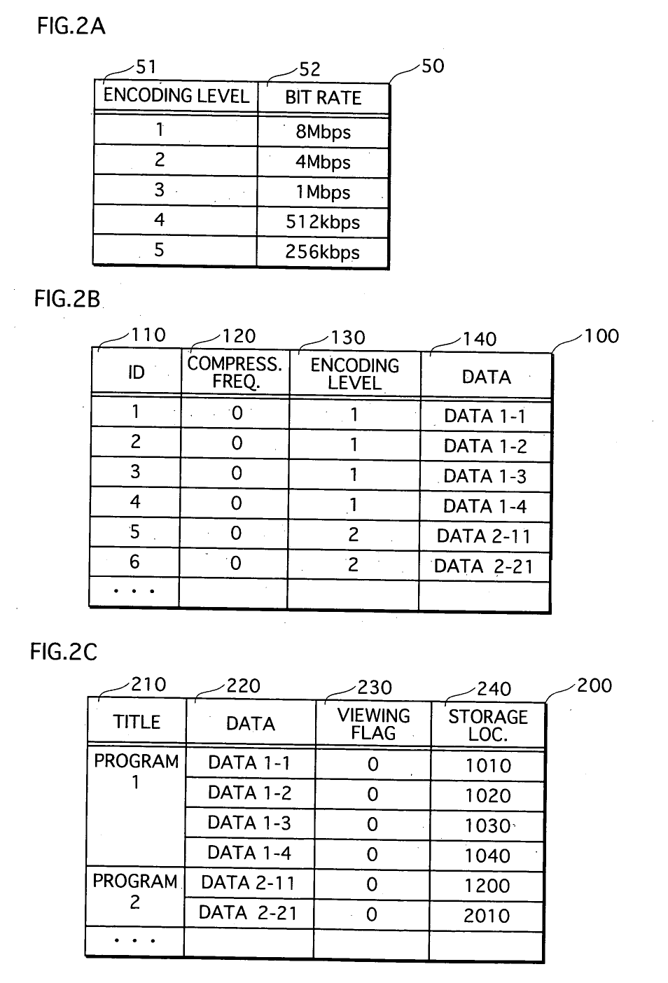

Table data recorded in information recording device 20 is described next using FIGS. 2A to 2C.

FIG. 2A shows a structure and an exemplary content of encoding information 50 referred to by encoding unit 22 when encoding program data and by compression unit 26 when compressing split data.

Encoding levels 51 in encoding information 50 are corresponded with bit rates 52 as shown in FIG. 2A.

Here, encoding levels 51 express encoding and compression levels, while bit rates 52 show encoding and compression bit rates.

Encoding information 50 prerecorded on fixed disk 24 or in a memory such as shared ROM (not depicted) is read by encoding unit 22 when encoding program data and by compression unit 26 when compressing split data decoded by playback unit 25.

FIG. 2B shows a structure and an exemplary content of header information 100 for both program data encoded by encoding unit 22 and split into units of fixed length by split recording unit 23, and split data compressed by compression unit 26.

IDs 110 in header information 100 are corresponded with compression frequencies 120, encoding levels 130 and data 140 as shown in FIG. 2B.

Here, IDs 110 are identifiers for uniquely identifying individual pieces of split data and compressed split data, and are appended whenever split data or compressed split data is generated by either split recording unit 23 or compression unit 26.

Compression frequencies 120 show the number of times that compression unit 26 has compressed respective pieces of split data and compressed split data.

Encoding levels 130 show the value of encoding levels 51 in encoding information 50 at which split data and compressed split data were either encoded or compressed by encoding unit 22 and compression unit 26.

Data 140 showing the correspondence between IDs 110 and split data/compressed split data is included to facilitate description.

Header information 100 is generated whenever split recording unit 23 records split data, read whenever compression unit 26 compresses decoded split data, and again generated whenever compression unit 26 records compressed split data.

FIG. 2C shows a structure and an exemplary content of link information 200 for program data recorded on fixed disk 24, in which program titles 210 are corresponded with data 220, viewing flags 230 and storage locations 240 as shown in FIG. 2C.

Program titles 210 show titles acquired from an EPG for programs selected for recording by the user.

Data 220 showing the correspondence between program titles 210 and split data/compressed split data is included to facilitate description.

Viewing flags 230 indicate whether the split data and compressed split data of data 220 have been read from fixed disk 24 by playback unit 25 and played back.

Storage locations 240 show the addresses in fixed disk 24 of individual pieces of split data and compressed split data, and are linked in playback order using a list structure. Note that in FIG. 2C the playback order is from the top.

Link information 200 is updated by split recording unit 23 when split data is recorded and by erase unit 27 when compression unit 26 records compressed split data.

Operations

The operations of information recording device 20 are described next.

Information recording device 20 receives input of program data for encoding from an external source via tuner 10, encodes the received program data, splits the encoded program data into units of fixed length, and records the split data to fixed disk 24.

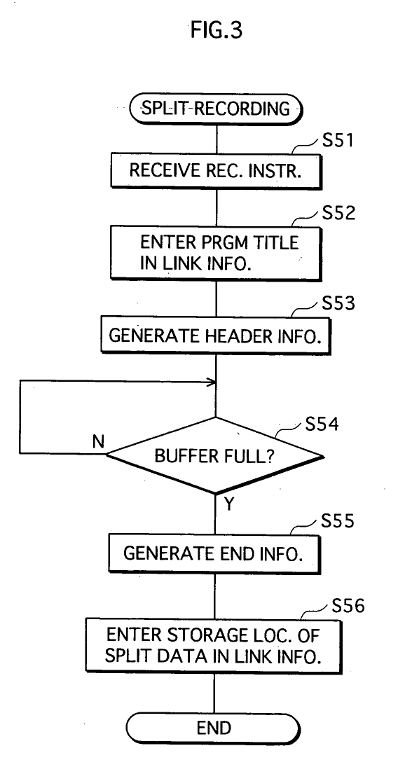

FIG. 3 is a flowchart of processing by split recording unit 23. These operations are described next in conjunction with FIG. 3.

Upon receiving a record instruction from the user (step S51), split recording unit 23 reads link information 200 and enters the program title acquired from an EPG received with the program data (step S52).

Split recording unit 23 receives the program data encoded by encoding unit 22 in a write buffer, and generates header information (step S53). Split recording unit 23 judges whether the write buffer is full (step S54), and continues to receive program data from encoding unit 22 until the write buffer is full. When the buffer is full (step S54=YES), split recording unit 23 generates end information (step S55), and records the program data to which the header information and end information is appended to fixed disk 24 as a single piece of split data. When recording the split data, split recording unit 23 enters the storage location in association with program title 210 in link information 200 in the playback order (step S56).

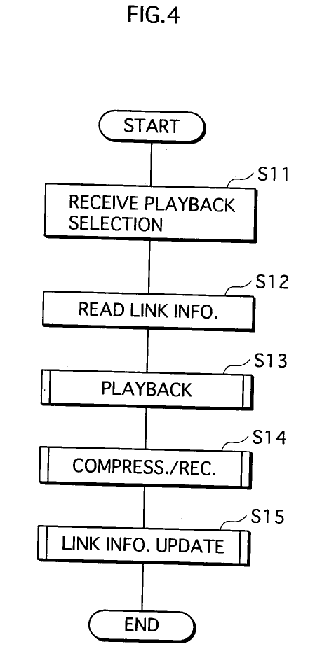

Operations performed when the user instructs playback of a program recorded on fixed disk 24 are described next using the FIG. 4 flowchart.

Upon receiving a user selection of a title of a program recorded on fixed disk 24 (step S11), information recording device 20 reads link information 200 for the program from fixed disk 24 (step S12).

Playback unit 25 sequentially reads split data constituting the selected program based on the read link information 200 and plays back the read data (step S13).

Compression unit 26 compresses split data that has been played back and records the compressed data to fixed disk 24 in parallel with the processing by playback unit 25 (step S14). Erase unit 27 updates the link information by replacing pre-compression storage locations with post-compression storage locations in parallel with the processing by compression unit 26 (step S15).

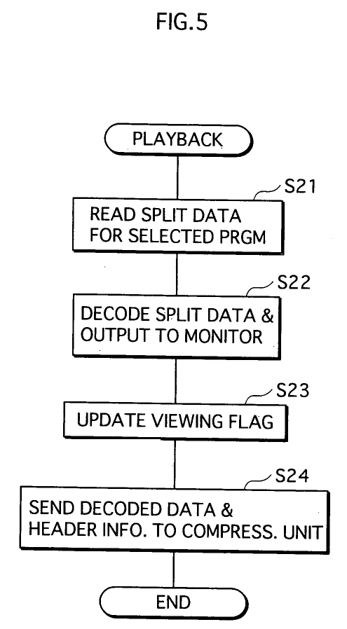

The above processing operations are described in detail below using FIGS. 5, 6 and 7.

FIG. 5 is a flowchart of processing by playback unit 25.

Playback unit 25 reads split data corresponding to the program title selected for playback to a read buffer based on link information 200 (step S21), decodes the read data in units of split data, and outputs the decoded data to monitor 30 via DAC 28 (step S22).

Playback unit 25 then updates viewing flag 230 in link information 200 of the decoded split data to “1” (step S23), and sends the decoded data and corresponding header information 100 to compression unit 26 (step S24).

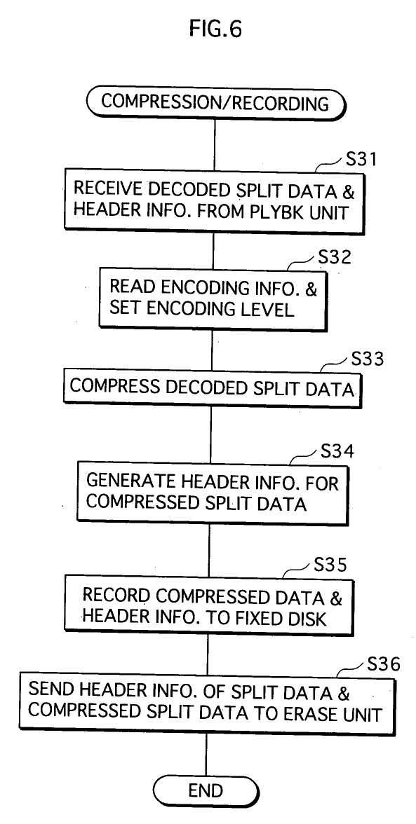

FIG. 6 is a flowchart of processing by compression unit 26.

Upon receiving decoded split data and corresponding header information 100 from playback unit 25 (step S31), compression unit 26 reads encoding information 50 and selects an encoding level corresponding to a bit rate that is lower than the bit rate corresponding to encoding level 130 shown in header information 100 (step S32).

Compression unit 26 then compresses the decoded split data at the bit rate corresponding to the selected encoding level (step S33), and generates header information 100 showing compression frequency 120 and encoding level 130 for the compressed data (step S34).

Following step S34, compression unit 26 records the compressed split data and generated header information 100 to fixed disk 24 (step S35), and sends header information 100 for both the pre-compression split data and compressed split data to erase unit 27 (step S36).

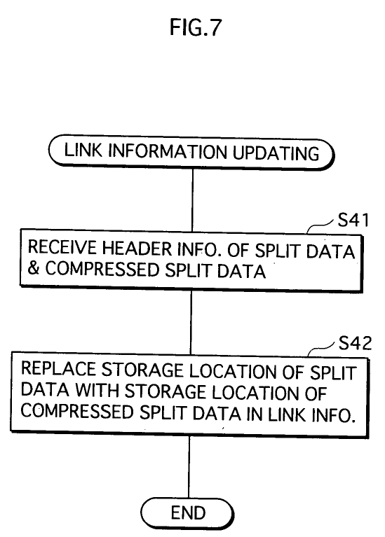

FIG. 7 is a flowchart of processing by erase unit 27.

Upon receiving header information 100 for both the split data and compressed split data sent from compression unit 26 at step S36 (step S41), erase unit 27 reads link information 200 from fixed disk 24, and replaces storage location 240 of the split data with the storage location of the compressed split data (step S42).

The storage area of split data whose storage location was replaced at step S42 of the above update processing is treated as free storage area on fixed disk 24, enabling split data and compressed split data to be newly recorded.

### WORKING EXAMPLE

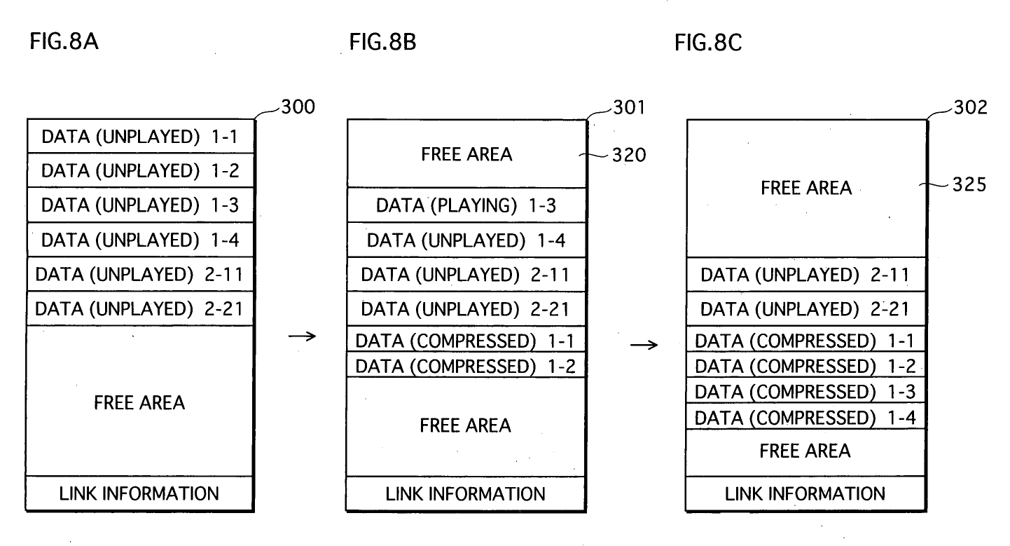

The above processing operations are described next using the example given in FIGS. 2A-2C and 8A-8C in conjunction with FIGS. 5, 6, and 7.

FIGS. 8A to 8C demonstrate the change in the storage area of fixed disk 24 when the user instructs playback of a program 1 entered in program title 210 of link information 200 (FIG. 2C). The rectangular boxes 300, 301 and 302 each represent fixed disk 24, and “DATA (UNPLAYED)” in FIG. 8A shows the individual pieces of data entered in data 220 of FIG. 2C.

In FIG. 5, playback unit 25, upon receiving a user instruction to playback program 1, reads link information 200 of program 1, and reads the split data constituting program 1 in order to the read buffer starting from data 1-1 (step S21).

Playback unit 25 then decodes data 1-1 read to the read buffer, and outputs decoded data 1-1 to monitor 30 via DAC 21 (step S22).

Following step S22, playback unit 25 updates viewing flag 230 of data 1-1 in link information 200 of program 1 to “1” (step S23), and sends decoded data 1-1 and header information 100 of data 1-1 to compression unit 26 (step S24).

The above processing is repeated for data 1-2 to 1-4 until a user instruction to end playback is received.

In FIG. 6, compression unit 26, upon receiving decoded data 1-1 and header information 100 from playback unit 25 (step S31), reads encoding information 50, and selects encoding level 2 corresponding to a lower bit rate than encoding level 1 of data 1-1 (step S32).

Following step S32, compression unit 26 compresses decoded data 1-1 at 4 Mbps, which is the bit rate corresponding to selected encoding level 2 (step S33), and generates header information showing compression frequency “1” and encoding level 121 for compressed data 1-1 (step S34).

Compression unit 26 records compressed data 1-1 and the newly generated header information to fixed disk 24 (step S35), and sends both the header information of data 1-1 and the newly generated header information to erase unit 27 (step S36).

In FIG. 7, erase unit 27, upon receiving both header information 100 of data 1-1 (FIG. 2B) and the header information of compressed data 1-1 (step S41), updates the link information of program 1 by replacing the storage location of data 1-1 with the storage location of compressed data 1-1 (step S42).

FIG. 8B shows a state in which data 1-2 has been processed in the same manner as data 1-1, and compressed data 1-1 and compressed data 1-2 have been recorded to fixed disk 24 during the playback of data 1-3, thus releasing the storage area of data 1-1 and data 1-2 for further recording as free area 320.

FIG. 8C shows a state in which data 1-3 and data 1-4 have also been fully processed, thereby creating expanded free area 325.

### Embodiment 2

The following description relates, in the case of certifier information showing a certifier for certifying the duplication of a program being appended to received program data, to an embodiment in which an information recording device transmits a certification request to the certifier based on the certifier information, and compresses/records split data that has been played back according to whether the duplication has been certified.

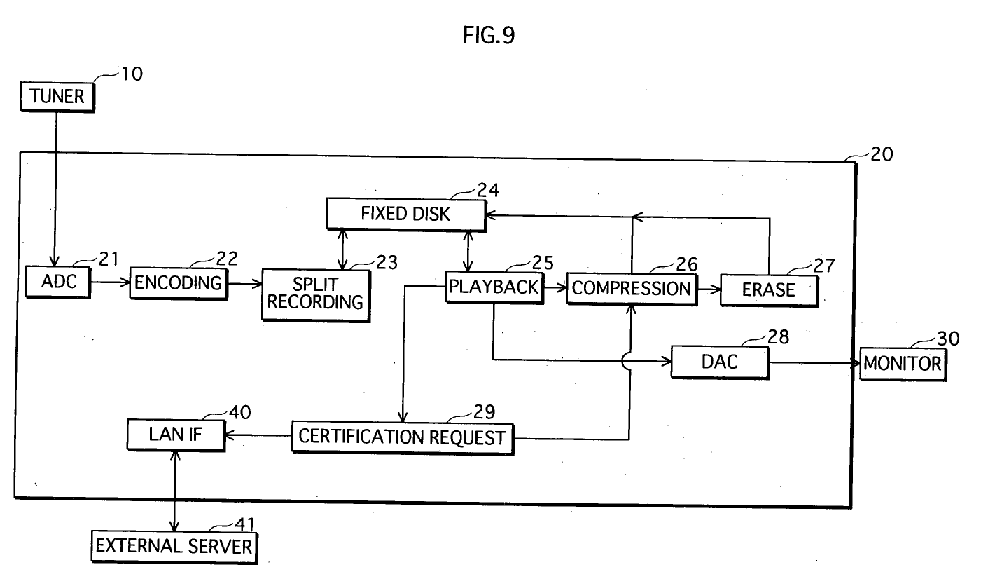

FIG. 9 is a structural view showing an embodiment 2 of information recording device 20 pertaining to the present invention.

As shown in FIG. 9, information recording device 20 of embodiment 2 is constituted from a certification request unit 29 and a LAN interface 40 in addition to the structure of FIG. 1, and can be connected to an external server 41 via LAN interface 40.

Certification request unit 29 functions to send a certification request relating to the duplication of split data to external server 41 via LAN interface 40 based on certifier information, and to receive response information relating to the certification request from external server 41 and send the response information to compression unit 26.

Note that received program data is here assumed to have certifier information denoted by a URL appended thereto, and split recording unit 23 is assumed to generate header information 100 that includes the certifier information and record the header information to fixed disk 24 together with the split data whenever split data is recorded.

Operations

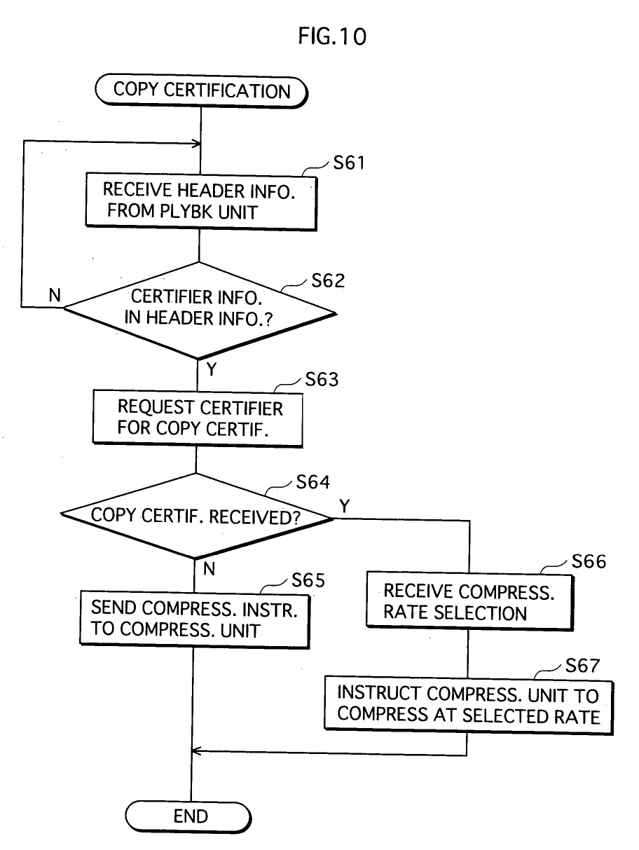

Operations performed by certification request unit 29 based on certifier information are described below using FIG. 10.

Playback unit 25 reads split data and header information relating to a program title selected by a user from fixed disk 24, and sends the read data and header information to certification request unit 29.

Upon receiving the header information from playback unit 25 (step S61), certification request unit 29 judges whether the header information includes certifier information (step S62).

If judged to include certifier information (step S62=YES), certification request unit 29 transmits a certification request to external server 41 via LAN interface 40 based on the certifier information in order to request the certifier to certify duplication of the split data (step S63).

If a copy certification certifying the duplication is received from external server 41 (step S64=YES), certification request unit 29 accepts selection of an encoding level (FIG. 2A) from the user (step S66), and instructs compression unit 26 to compress the split data at the selected encoding level.

Upon receiving information such as COPY ONCE indicating that duplication is not certified (step S64=NO), certification request unit 29 instructs compression unit 26 to compress the split data at a lower bit rate than the split data (step S65).

Variations

The following description relates to variations of embodiment 1 of information recording device 20 pertaining to the present invention.

Variation 1

In embodiment 1, split data that has been played back is targeted for compression, although if the free area falls below a prescribed threshold during the recording of program data by split recording unit 23, compressed split data recorded on fixed disk 24 may be designated for further compression, and the processing of compression unit 26 and erase unit 27 performed on the designated data.

In this case, split recording unit 23 judges whether the free area on fixed disk 24 is at or below a prescribed threshold, and notifies compression unit 26 of the judgment result if judged in the affirmative.

Upon receiving an affirmative judgment result from split recording unit 23, compression unit 26 reads link information 200, reads encoding information 50 and header information 100 for each piece of compressed split data whose viewing flag is “1”, designates those pieces of compressed split data whose encoding level 130 is other than “5” as data for compressing, and compresses/records the designated data.

Note that in the case of compressed split data being targeted for compression, compressed split data whose encoding level is other than “5” may be prioritized in ascending order of the encoding frequencies.

Variation 2

In embodiment 1, compression unit 26 compresses decoded split data at a lower bit rate than the bit rate of encoding level 130 in corresponding header information 100, although the encoding level may be varied according to the type of program included in the split data.

For example, if non-program content (e.g. commercial messages) is recognized by the attribute of audio signals included in split data being “stereo” and program content is recognized by the audio attribute being “monaural”, the program type of a piece of split data is set to “program content” when it is program content that the split data includes.

In this case, split recording unit 23 appends content information to the header information of individual pieces of split data that shows whether the split data includes program content or non-program content. Here, it is assumed that the encoding bit rate is preset depending on whether the content information shows program content or non-program content, and that the bit rate in the case of non-program content is set lower than for program content.

Note that split recording unit 23 may split the program data into segments corresponding to program content and segments corresponding to non-program content.

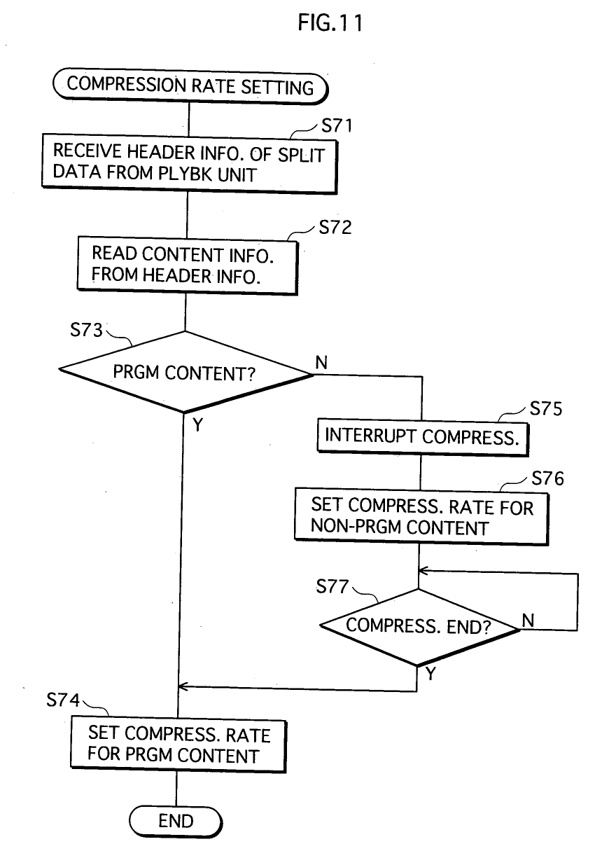

The following description using FIG. 11 relates to processing by compression unit 26 to set the encoding level based on content information included in header information received from playback unit 25.

Upon receiving the header information of decoded split data from playback unit 25 (step S71), compression unit 26 reads the content information (step S72), and judges whether the content information shows program content (step S73).

If judged in the affirmative (step S73=YES), compression unit 26 sets the compression rate for program content (step S74), and if judged in the negative (step S73=NO), compression unit 26 interrupts the compression processing (step S75), sets the compression rate for non-program content, recommences the compression processing, and sends a signal instructing playback unit 25 to restart playback (step S76). The compression rate is maintained at the non-program content rate until the split data whose content information shows non-program content has been processed (step S77=YES), at which point the compression rate is set for program content (step S74).

Additional Remarks

The present invention, which has been described above based on embodiments 1 and 2 of an information recording device, is of course not limited to these embodiments. The following modifications are also possible.

(1) Compression unit 26 performs the compression in the preferred embodiments, although encoding unit 22 may be used if the same encoding as that performed by encoding unit 22 is applied as the compression scheme. In this case, playback unit 25 sends decoded split data to encoding unit 22, which switches from receiving input from ADC 21 to playback unit 25, and performs encoding in order to compress the decoded data. This structure enables hardware costs to be cut by sharing processing blocks.

(2) In the preferred embodiments, encoded program data is split into fixed units and recorded to fixed disk 24, although the program data may be recorded to fixed disk 24 without being split into fixed units.

In the case of only part of a program being played back, for example, playback unit 25 reads corresponding program data from fixed disk 24, and stores the recording start and end positions in memory when the program data has been read. Compression unit 26 compresses and records the decoded program data sent from playback unit 25, and generates header information for the compressed program data when the recording is performed. Erase unit 27 generates link information that causes both the post-compression storage location of the compressed data to be read instead of the recording start position in memory, and the recording end position in memory to be read after the post-compression storage location of the compressed data.

(3) If data that requires updating (e.g. commercial messages) is included in received program data together with information showing the CM provider, information recording device 20 may acquire update data from the CM provider when the program data is played back, and substitute the latest CM data.

In this case, split recording unit 23 splits the program data into segments corresponding to commercial messages and segments corresponding to program content depending on whether the program data relates to commercial messages or program content, and appends content information to the header information for individual pieces of split data as in the above variation 2.

Playback unit 25 acquires the latest CM data from the CM provider when the content information in header information for split data read from fixed disk 24 shows CM, replaces the split data with the acquired CM data, and plays back the latest CM data.

Compression unit 26 compresses and records the decoded latest CM data received from playback unit 25.

(4) In the preferred embodiments, the write buffer capacity is used as the criterion for splitting program data, although program data equal to a unit of capacity other than buffer capacity or program data received in the write buffer over a fixed time period may be treated as split data.

(5) In the preferred embodiments, split data decoded by playback unit 25 is compressed at a bit rate corresponding to an encoding level higher by one level than the encoding level of the split data, although the decoded split data may be compressed at any encoding level or at an encoding level selected by the user provided the bit rate used is lower than the original bit rate.

(6) In the above variation 1, compression unit 26 targets compressed split data recorded on fixed disk 24 for further compression in the case of free area on fixed disk 24 falling below a prescribed threshold during the recording by split recording unit 23 of split data constituting a program. However, program data received in the write buffer or recorded split data of the program being recorded may be designated for compression. In this case, compression unit 26 compresses the designated data at a lower bit rate than that used by encoding unit 22, and sets the compression frequency in corresponding header information to “1”.

(7) In the preferred embodiments, all of the compressed split data is recorded to fixed disk 24, although compressed data may be recorded to a portable device such as a DVD. In this case, information relating to the portable device is added to the link information. In the case of copy control information (e.g. COPY ONCE) being appended to received program data, the program data may be recorded to the portable device after being compressed at a higher compression rate than the original program data, and the original data erased.

(8) A computer program for having a processor execute the processing operations (FIGS. 3, 5, 6, 7) performed by an information recording device pertaining to the present invention can also distributed by either being recorded on a recording medium for circulation or being circulated via any of various types of communication channels. Exemplary recording media include IC cards, hard disk, optical disks, flexible disks, and ROM. The distributed computer program can then be submitted for use by being stored in a processor-readable memory or the like, and the functions of an information recording device pertaining to the present invention realized by the processor executing the computer program.

Note that an information recording device pertaining to the present invention can be used by being loaded in hard disk recorders, DVD recorders, and the like.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An information recording device for compressing video data constituting a video stream read from a recording medium storing reference information that shows a storage location of the video data and is referred to in order to read the video data as the video stream, comprising:
a reading unit operable to read part of the video data;
a compressing unit operable to compress the read data and record the compressed data to the recording medium; and
an updating unit operable, when the compressed data is recorded, to update the reference information to show the storage location of the compressed data rather than the read data.

2. The information recording device of claim 1, wherein
the video data consists of plural pieces of split video data,
the reference information shows a storage location of each piece of split video data and a reference order of the storage locations,
the read video data is a piece of the split video data, and
the updating unit updates the reference information when the compressed split data is recorded to show the storage location of the compressed split data rather than the read split data.

3. The information recording device of claim 2, wherein
at least one piece of the split video data includes duplication information that indicates a certifier relating to duplication of the piece of split video data, and
the information recording device further comprises:
a certification requesting unit operable, if the read split data includes the duplication information, to send a certification request to and receive a response from the certifier; and
a control unit operable to control the compressing and recording by the compressing unit according to the received response.

4. The information recording device of claim 1 further comprising:
a capacity judging unit operable to judge whether a free capacity of the recording medium is at or below a prescribed threshold; and
a recording unit operable to record video data constituting an externally acquired video stream to the recording medium together with the reference information, wherein
if judged in the affirmative during recording of the video stream, the reading unit, the compressing unit and the updating unit perform the reading, compressing/recording and updating on video data of the video stream being recorded.

5. The information recording device of claim 2, wherein
each piece of split video data includes all or part of one of plural types of programs and classification information indicating the type of the program, and
the compressing unit changes the compression rate at which the read split data is compressed depending on the classification information included therein.

6. The information recording device of claim 2, wherein
at least one piece of the split video data includes data that requires updating,
the reading unit includes an acquiring subunit operable to judge whether the read split data includes data that requires updating, and externally acquire update data if judged in the affirmative, and
the compressing unit compresses and records the read split data after replacing the data that requires updating with the acquired update data.

7. A computer program for causing a computer to execute processing to compress video data constituting a video stream read from a recording medium storing reference information that shows a storage location of the video data and is referred to in order to read the video data as the video stream, comprising the steps of:
reading part of the video data;
compressing the read data and recording the compressed data to the recording medium; and
updating the reference information when the compressed data is recorded to show the storage location of the compressed data rather than the read data.
